(19) United States
(12) Patent Application Publication
(10) Pub. No.: US 2008/0313568 A1
(43) Pub. Date: Dec. 18, 2008

(54) DIGITAL MULTIMEDIA PLAYBACK APPARATUS AND CONTROL METHOD THEREOF

(75) Inventors: Bo-eun Park, Seongnam-si (KR); Jong-sung Joo, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/942,848

(22) Filed: Nov. 20, 2007

(30) Foreign Application Priority Data
Jun. 12, 2007 (KR) 2007-57405

(51) Int. Cl. G06F 3/048

(52) U.S. Cl. 715/835

(57) ABSTRACT

A digital multimedia playback apparatus and a control method thereof in which a user starts touching, on a touch screen, one of an item and a function icon ends touching the other one of the item and function icon to control the items and functions displayed thereon. The digital multimedia playback apparatus includes a touch screen to change the state of the item to the state that corresponds to the function icon; thus, the user can more easily edit files or the like.

### CROSS-REFERENCE TO RELATED APPLICATION

This application claims the benefit of Korean Application No. 2007-57405, filed Jun. 12, 2007 in the Korean Intellectual Property Office, the disclosure of which is incorporated herein by reference.

### BACKGROUND OF THE INVENTION

1. Field of the Invention

Aspects of the present invention relate to a digital multimedia playback apparatus and a control method thereof, and more particularly, to a digital multimedia playback apparatus, in which user commands are input through a touch screen, and a control method thereof.

2. Description of the Related Art

Touch screens are generally applied to personal digital assistants (PDAs) or video apparatuses which are contained in digital multimedia playback apparatuses. Users input commands through touch screens, and the commands may be more intuitively input and the convenience of using digital multimedia may be improved. Additionally, separate operation buttons are not required on the touch screens, so digital multimedia playback apparatuses have been steadily reducing in size.

However, a conventional menu interaction method used in hard buttons is still being used even in products with touch screens. In other words, if a user wishes to delete a file stored in a predetermined storage unit, the user opens a menu and searches for a predetermined file. The user then opens the menu again when the searched file is being displayed and searches for a delete function. Accordingly, when editing files, the user may experience greater inconvenience when using the touch screen than when using the conventional hard buttons.

### SUMMARY OF THE INVENTION

Aspects of the present invention relate to a digital multimedia playback apparatus and a control method thereof, in which user commands can be performed more intuitively in a product to which a touch screen is applied.

According to an aspect of the present invention, there is provided a digital multimedia playback apparatus, which may be a video camcorder, including a display unit comprising a touch screen to display a list of items and a function icon; and a controller to change the state of an item of the list to the state corresponding to the function icon if a first user command is input using the item and the function icon.

According to an aspect of the present invention, the first user command input may start by touching one of the item and the function icon and end by touching the other one of the item and the function icon.

According to an aspect of the present invention, the function icon may comprise one of a trash icon, a protection icon, and a playlist icon.

According to an aspect of the present invention, if the function icon is the trash icon, the controller may delete the touched item from a storage unit in which the touched item is stored. If the function icon is the protection icon and if a command to delete the list is input, the controller may delete other items of the list, excluding the touched item, and if the function icon is the playlist icon, the controller may store the touched item in a storage unit for a playlist.

According to an aspect of the present invention, if the list is an icon list and if a user command input starts by touching one of an item of the icon list and the function icon and ends by touching the other one of the item and the function icon, the controller may exchange on the display unit the position of the touched item with the position of the function icon, and controls the touched item so that the touched item can operate as a function icon.

According to an aspect of the present invention, if a second user command is input by touching the function icon, the controller may control the display unit to display the items of the states that correspond to the function icon.

According to an aspect of the present invention, there is provided a control method of a digital multimedia playback apparatus comprising a touch screen, the method including displaying a list of items and a function icon; and changing the state of an item of the list to the state corresponding to the function icon if a first user command is input on the touch screen using the item and the function icon.

According to an aspect of the present invention, the first user command input may start by touching one of the item and the function icon and end by touching the other one of the item and the function icon.

According to an aspect of the present invention, the function icon may comprise a trash icon, a protection icon and a playlist icon.

According to an aspect of the present invention, if the function icon is the trash icon, the changing may include deleting the touched item from a storage unit in which the touched item is stored. If the function icon is the protection icon and if a command to delete the list is input, the changing may include deleting other items of the list, excluding the touched item, and if the function icon is the playlist icon, the changing may include storing the touched item in a storage unit for a playlist.

According to an aspect of the present invention, if the list is an icon list and if a user command input starts by touching one of an item of the icon list and the function icon and ends by touching the other one of the item and the function icon, the changing may include exchanging the position of the touched item with the position of the function icon, and controlling so that the touched item can operate as a function icon.

According to an aspect of the present invention, if a second user command is input by touching the function icon, the changing may include controlling the display unit to display the items of the states that correspond to the function icon.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a digital multimedia playback apparatus to which aspects of the present invention are applicable;

FIG. 2 is a flowchart explaining a process of editing an item, according to aspects of the present invention;

FIGS. 3A to 3F are views related to a process of deleting a predetermined file from a file list comprising video thumbnails as described in FIG. 2;

FIGS. 4A and 4B are views related to a process of touching a function icon and dragging the touched icon to a file item, according to aspects of the present invention;

FIG. 5 is a view illustrating a file list comprising text according to aspects of the present invention; and

FIGS. 6A to 6D are views related to lists comprising icons according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain aspects of the present invention with reference to the figures.

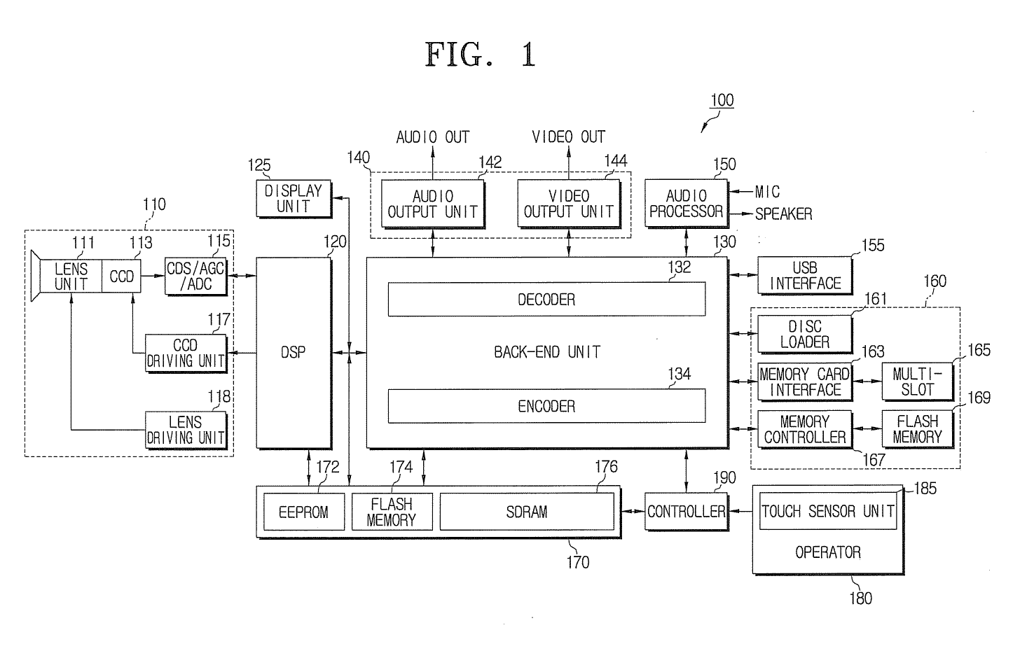

FIG. 1 is a block diagram of a digital multimedia playback apparatus, specifically a digital camcorder 100, to which aspects of the present invention are applicable. In FIG. 1, the digital camcorder 100 according to aspects of the present invention provide a capturing unit 110, a digital signal processor (DSP) 120, a display unit 125, a back-end unit 130, an output unit 140, an audio processor 150, a universal serial bus (USB) interface 155, a recording unit 160, a storage unit 170, an operator 180, and a controller 190.

The capturing unit 110 converts an optical signal input through a lens to an electrical signal and performs a predetermined signal processing of the electrical signal. The capturing unit 110 includes a lens unit 111, a charge coupled device (CCD) 113, a correlated double sampler (CDS)/automatic gain controller (AGC)/analog-to-digital converter (ADC) 115, a CCD driving unit 117, and a lens driving unit 118.

The lens unit 111 forms an optical image of an object on an optical plane of the CCD 113 to be described later. The lens driving unit 118 operates the lens unit 111. Specifically, the lens driving unit 118 operates the lens unit 111 by driving a zoom motor (not shown) to perform zoom-in and zoom-out functions, by driving a focus motor to adjust the focus or focal length of the lens, and by driving an iris motor to control the degree to which an iris (not shown) of the lens unit 111 is open.

The CCD 113 is operated by the CCD driving unit 117 and is a capturing device which converts video images captured through the lens unit 111 to an electrical signal. The CCD 113 may output signals accumulated every 1/30 of a second (that is, a period of time equivalent to a single frame), or every 1/60 of a second (that is, a period of time corresponding to a single field). However, it is understood that the CCD 113 is not limited thereto such that the CCD may output signals accumulated every 1/128 of a second or another shorter or longer period of time. Further, it is understood that the digital camcorder 100 according to aspects of the present invention may include a complementary metal oxide semiconductor (CMOS) capturing device instead of or together with the CCD 113.

The CDS/AGC/ADC 115 performs signal processing, such as correlated double sampling, automatic gain control, and analog/digital (A/D) conversion, of the electrical signal output from the CCD 113. The DSP 120 performs signal processing with respect to the video signal output from the capturing unit 110, and outputs the processed signal to the back-end unit 130 and/or the display unit 125. Specifically, the DSP 120 can convert the format of the video signal output from the capturing unit 110 and can process the video signal according to setting information such as digital zoom information to adjust the scale of the video, automatic white balancing (AWB) information or other information, and output the processed video signal to the back-end unit 130 and/or the display unit 125. Additionally, the DSP 120 can perform automatic focus (AF) and automatic exposure (AE) functions under the control of the lens driving unit 118.

The display unit 125 is contained in a display device for displaying text, icons or the like, and/or the video signal output from the DSP 120 or the back-end unit 130. The display unit 125 may be implemented as a touch screen through which user commands are received.

The back-end unit 130 performs signal processing such as compression, expansion, and playback, with respect to a video signal and/or an audio signal. The back-end unit 130 includes at least a decoder 132 and an encoder 134. Specifically, the decoder 132 retrieves a video signal received from the recoding unit 160, decodes the retrieved video signal so as to be suitable for display, and outputs the decoded video signal to a video output unit 144 and/or the display unit 125. If the decoded video signal is output to the video output unit 144 and/or the display unit 125, the back-end unit 130 can perform on-screen-display (OSD) processes on the decoded video signal. If a moving image is recorded in the recording unit 160, the decoder 132 may decode the audio signal.

The encoder 134 compresses the video signal received from the DSP 120 and the audio signal received from the audio processor 150 into a predetermined format and transfers the compressed files to the recording unit 160.

The back-end unit 130 can perform a switching function to transfer the video signal received from the DSP 120 and the audio signal received from the audio processor 150 to the output unit 140. The output unit 140 outputs the video and/or audio signals output from the back-end unit 130 to an external apparatus (for example, a TV).

The audio processor 150 converts an analog audio signal input through an audio input device, such as a microphone, into a digital audio signal and transfers the digital audio signal to the back-end unit 130. Additionally, the audio processor 150 converts the digital audio signal output from the back-end unit 130 into an analog audio signal and outputs the analog audio signal to a speaker.

The USB interface 155 provides a USB communication interface between devices, such as a personal computer (PC) and/or a printer, and the digital camcorder 100. However, it is understood that other interfaces, such as USB 2.0, or an IEEE 1394 interface, can be used in addition to or instead of USB. Further, a wireless interface can be used.

The recording unit 160 records the compressed files output from the back-end unit 130 in a recording medium. The recording unit 160 includes a disc loader 161, a memory card interface 163, a multi-slot 165, a memory controller 167, and flash memory 169. The disc loader 161 writes the compressed files input from the back-end unit 130 on a built-in disc. Additionally, the disc loader 161 reads the compressed files written on the built-in disc, and outputs the read files to the back-end unit 130. The disc may be a compact disc (CD), a digital versatile disc (DVD), a Blue-ray disc (BD), or a high definition-DVD (HD-DVD).

The memory card interface 163 writes the compressed files input from the back-end unit 130 to various memory cards mounted in the multi-slot 165. Additionally, the memory card interface 163 reads the compressed files written on the various memory cards mounted in the multi-slot 165 and outputs the read files to the back-end unit 130. The memory card may be multimedia card (MMC), a secure digital (SD) card, or any other memory device, such as a removable hard disk, or a portable flash device.

The memory controller 167 writes the compressed files input from the back-end unit 130 to the flash memory 169, which is a built-in memory. The memory controller 167 also reads the compressed files written on the flash memory 169, and outputs the read files to the back-end unit 130. The disc, memory card and flash memory 169 are used as recording media. Besides the above-described recording media, aspects of the present invention are also applicable to a hard disk drive (HDD), a detachable recording medium, and/or tape media.

The storage unit 170 stores information regarding programs required to control a system of the digital camcorder 100, setting information of the digital camcorder 100, and icon information. The storage unit 170 includes an electrically erasable and programmable read only memory (EEPROM) 172, a flash memory 174 and a synchronous dynamic random memory (SDRAM) 176. The EEPROM 172 may store information, for example setting information of the digital camcorder 100, icon information and program information related to icons, which is retained even after the power source is turned off. The flash memory 174 may store programs required to control the back-end unit 130 and multimedia content, and the SDRAM 176 may be used as a storage space in which various data are backed up temporarily. In order to upgrade the programs required to control the digital camcorder 100, upgrade programs may be downloaded from an external apparatus connected via a communication line, and the downloaded programs may be stored in the flash memory 174 and then used. Data stored in the EEPROM 172 and flash memory 174 may remain even after the power source is turned off, but data stored in the SDRAM 176 may be deleted.

A storage unit for trash and a storage unit for a playlist may be provided in the flash memory 174 or the EEPROM 172. The storage unit for trash may temporarily store files deleted by a user, and the storage unit for a playlist may store files added to the playlist by a user.

The operator 180 serves as a device to receive user commands and transfer the user commands to the controller 190. The operator 180 may be attached to or detached from a video apparatus, and, as such, the operator 180 may transfer the user commands to the controller 190 via wired or wireless connections. According to aspects of the present invention, the operator 180 may be implemented as a touch screen and may include a touch sensor unit 185. In such case, every time a touch is detected, a plurality of touch sensors of the touch sensor unit 185 transfer a result of the detection to the controller 190.

The controller 190 controls the entire operation of the digital camcorder 100. If a user command is input through the operator 180, the controller 190 may control various function blocks of the digital camcorder 100 so that the digital camcorder 100 is operated in response to the user command. For example, if a user touches and drags a protection icon to an item of the list on the screen of the operator 180 on which the list of items and function icons are displayed, a file corresponding to the item can be protected. Accordingly, even when a command to delete the list is input, the protected file cannot be deleted.

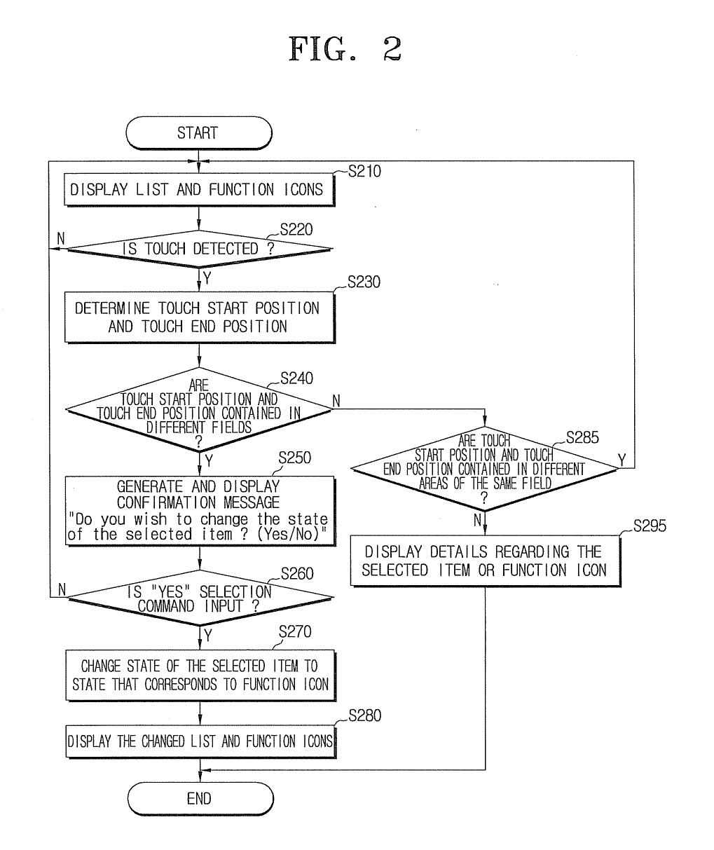

FIG. 2 is a flowchart explaining a process of editing an item according to aspects of the present invention. The list and function icons are displayed on the display unit 125 in operation S210. The list may be a list related to video, audio, text or other files and may comprise text, images, or video. Additionally, the function icons may be symbols representing functions used in an edit mode of the digital camcorder 100, including delete, protection, display playlist, bookmark icons, or other function icons.

The touch sensor unit 185 determines whether a user's touch is detected in operation S220. A user may start touching, on the touch screen of the operator 180, one of an area indicating an item of the list and an area indicating a function icon, may drag the touched area on the touch screen, and may stop touching the touch screen of the operator 180 in the other one of the area indicating the item of the list and the area indicating the function icon. Accordingly, a touch sensor of the touch sensor unit 185 corresponding to the touched area may detect the user's touch and may transfer the detection result to the controller 190.

The controller 190 determines a touch start position and a touch end position using the detection results transferred from the touch sensor unit 185 in operation S230. For example, if a user touches and drags an area indicating a second file on the file list to an area indicating a delete icon, the controller 190 may determine the area indicating the second file and the area indicating the delete icon, respectively, to be a touch start position and a touch end position.

The controller 190 may also determine whether the touch start position and the touch end position are in different fields in operation S240. For example, if the touch start position is contained in a field in which the list is shown and if the touch end position is contained in a field in which the function icons are shown, the controller 190 may determine that the touch start position and the touch end position are in different fields. Even though the items in the list may be in the same field, the areas indicating each item of the list may differ from each other.

If it is determined that the touch start position and the touch end position are in different fields in operation S240-Y, the controller 190 may generate a confirmation message to confirm whether a user wishes to change the state of the item (hereinafter, referred to as “selected item”) corresponding to the touch start position or the touch end position and may allow the generated message to be displayed on the display unit 125 in operation S250. In other words, the controller 190 may generate a confirmation message to confirm whether a user wishes to change the state of the selected item on the list to the state corresponding to the function icon. For example, if the selected item is a video file and if the function icon is the delete icon, the controller 190 may generate a message stating “Delete selected files? Yes/No” and may allow the generated message to be displayed on the display unit 125.

Subsequently, the controller 190 determines whether the user selects “Yes”, according to the detection result transferred from the touch sensor unit 185 in operation S260. When the user reads the message displayed on the display unit 125, the user may confirm his or her intention to delete the selected file, and may touch a box indicating “Yes”.

If it is determined that “Yes” is selected in operation S260-Y, the controller 190 may change the state of the selected file according to the function icon in operation S270. In other words, the controller 190 may delete the selected file from the storage unit 170 in which the file had been stored and the deleted file may be placed in the storage unit 170 for trash. However, if the user selects “No” in operation S260-N, the controller 190 causes the list and function icons to be displayed on the display unit 125 and returns to the operation S210.

The controller 190 controls the function blocks of the digital camcorder 100 so that the function icons and the changed list can be displayed on the display unit 125 in operation S280. Specifically, if the second video file is deleted, the controller 190 may change the list based on the video files, excluding the second video file, and may allow the changed list and the function icons to be displayed on the display unit 125.

However, if it is determined that the touch start position and the touch end position are in the same field in operation S240-N, the controller 190 determines if the touch start position and the touch end position are contained in different areas of the same field in operation S285. If it is determined that the touch start position and the touch end position are contained in different areas of the same field in operation S285-Y, the controller 190 may display the original list and the function icons without change as in operation S210. Specifically, if the touch start position and the touch end position are determined to be in an area indicating the second file and an area indicating a third file, respectively, the controller 190 may determine that the touch start position and the touch end position are contained in different areas of the same field. The controller 190 may leave the original list and function icons displayed on the display unit 125 unchanged. However, it is understood that the controller 190 may detect that the touch start position indicates a second file and the touch end position indicates a third file and cause the list to be displayed with a changed order such that the second file is displayed in the previous position of the third file and the third file is displayed in a previous position of the second file. Further, the controller 190 may take other actions when the touch start position indicates a second file and the touch end position indicates a third file; for example, the second and third files could be merged together into one larger file, or the second file could be copied to replace the third file.

Alternatively, if it is determined that the touch start position and the touch end position are contained in the same area of the same field in operation S285-N, the controller 190 may control the function blocks of the digital camcorder 100 so that details regarding the item selected from the list or the selected function icon can be displayed in operation S295. For example, if a user starts and stops touching the delete icon, the controller 190 may determine that the delete icon is selected. Accordingly, the controller 190 may read the details regarding the selected icon, that is, the deleted items stored in the storage unit for trash, may generate a list of the deleted items, and may control the function blocks to display the generated list of the deleted items on the display unit 125.

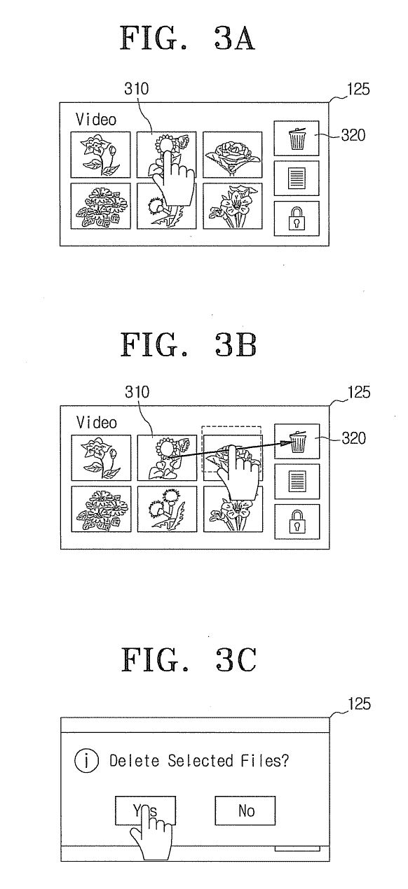

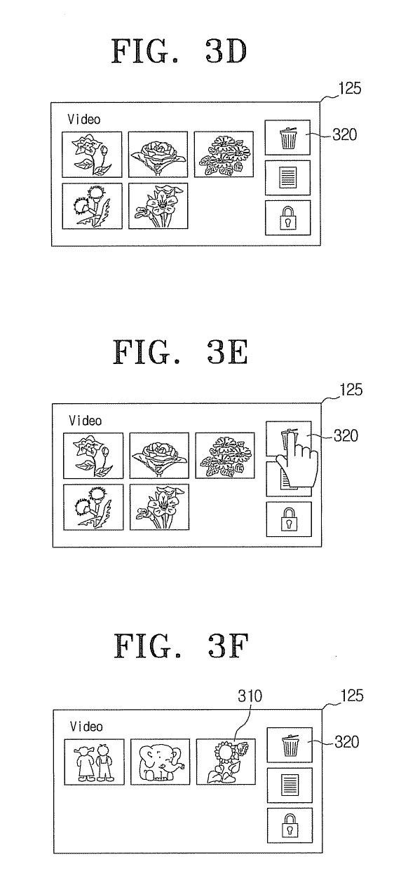

Hereinafter, an editing process, such as described above, will be described in greater detail with reference to FIGS. 3A to 3F. FIGS. 3A to 3F are views related to a process of deleting a predetermined file from the file list comprising video thumbnails as described in FIG. 2.

A user touches a second file 310 on the file list comprising the thumbnails as displayed on a display unit 125, as shown in FIG. 3A, and drags the touched second file 310 to an area indicating a trash icon 320 before releasing his or her finger from the touch screen, as shown in FIG. 3B. A message stating “Delete selected files? Yes/No” may then be displayed on the display unit 125 as shown in FIG. 3C. If the user touches the box indicating “Yes”, a new file list, excluding the second file 310, may be displayed on the display unit 125 as shown in FIG. 3D. However, if the user touches the box indicating “No”, then the original list including the touched second file 310 is displayed as shown in FIG. 3A. Further, it is understood that the user is not limited to dragging the touched second file 310 to the area indicating the trash icon 320; rather, the user may touch the second file 310 and sequentially touch the trash icon 320 to the same effect as dragging touched second file 310.

In FIGS. 3E and 3F, if the user touches the area indicating the trash icon 320, a file list comprising the deleted files may be displayed on the display unit 125. In such case, the controller 190 determined that the touch start position and the touch end position were contained in the same area of the same field as in operation S285-N so that the details regarding the item selected from the list or the selected function icon (i.e., the trash icon 320) are displayed as in operation S295. As the deleted files are stored in the storage unit for trash if the user moves the files to the trash icon 320, the files stored in the storage unit for trash may be shown. Accordingly, the deleted second file 310, as deleted in FIGS. 3A to 3D, may be displayed on the display unit 125 as shown in FIG. 3F. The function icons may function as a menu, so the user can more conveniently use the digital camcorder 100.

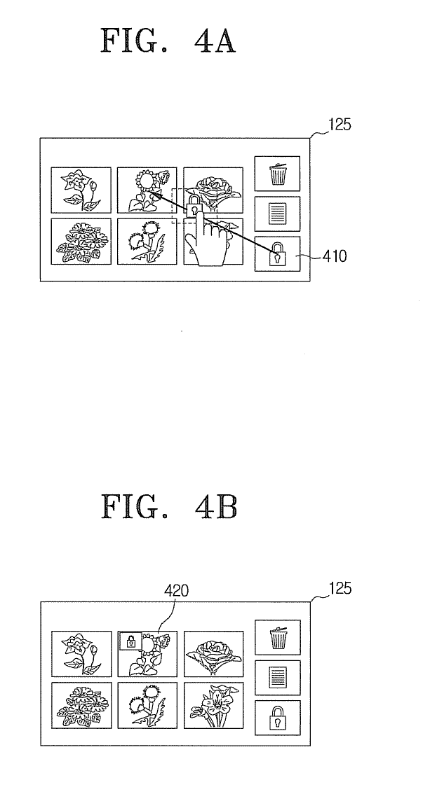

FIGS. 4A and 4B are views related to a process of touching a function icon and then dragging the touched function icon to a file item according to aspects of the present invention. Although a user may start touching an area indicating an item and then stop touching at an area indicating a function icon according to aspects of the present invention as described above with reference to FIGS. 3A through 3F, this process may be reversed. In other words, a user may touch a protection icon 410 displayed on the display unit 125 and drag the protection icon 410 to a predetermined file 420 before releasing his or her finger from the touch screen as shown in FIG. 4A. Accordingly, the predetermined file 420 may be protected as shown in FIG. 4B.

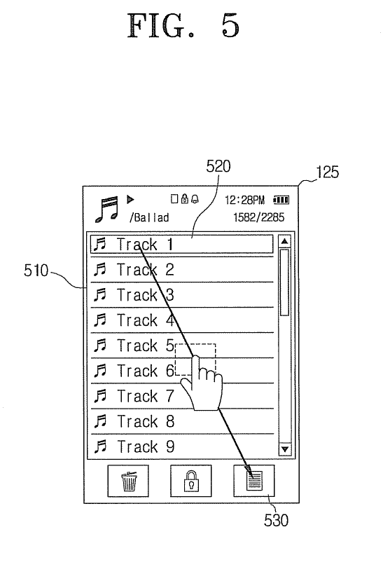

FIG. 5 is a view illustrating a file list comprising text according to aspects of the present invention. According to aspects of the present invention, the file list 510 displayed on the display unit 125 can comprise text, in addition to video. Furthermore, the file list 510 can be manipulated to create a play list. As shown in FIG. 5, Track 1 520 is selected and being dragged to the playlist function icon 530 to be included with other tracks to be reproduced. As described above with reference to FIGS. 3E and 3F, the playlist function icon 530 could be touched to display the files stored in therein.

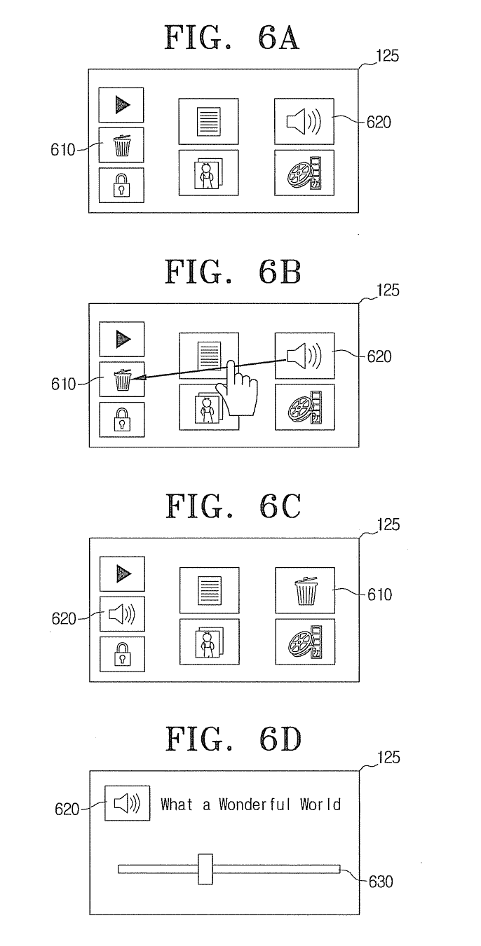

FIGS. 6A to 6D are views related to lists comprising icons according to aspects of the present invention. Function icons currently used are arranged vertically on the left side of the display unit 125, and an icon list of function icons is disposed in the center and on the right side of the display unit 125. The function icons displayed on the display unit 125 are included in a same field. The function icons are considered currently used as the currently used function icons appear in one field of a display that displays at least two fields; for example, the trash icon 320 of FIG. 3A is a currently used function icon, The user can change the position of the function icons. For example, when a user desires to listen to music, a volume icon 620 may be used more frequently than a trash icon 610. As such, the user may set the volume icon 620 to be a function icon instead of the trash icon 610. Accordingly, the user may touch and drag an area indicating the volume icon 620 to an area indicating the trash icon 610 before releasing his or her finger from the touch screen as shown in FIG. 6B, and thus the volume icon 620 can be displayed as a function icon instead of the trash icon 610, as shown in FIG. 6C. As such, the touch start position would be determined to be in a first area indicating a first function icon in a field (i.e., the volume icon 620), and the touch end position would be in a second area indicating a second function icon in the same field (i.e., the trash icon 610), one of the first and second function icons being currently used, and the first function icon and the second function icon would switch states so that the other of the first and second function icons would become currently used (i.e., the volume icon 620 would become currently used and displayed in one of the fields displayed in FIG. 3A). Additionally, if the user selects the volume icon 620 in order to adjust the volume, a volume bar 630 may be displayed, as shown in FIG. 6D, so that the volume can be adjusted.

As described above, the files or the icons displayed on the display unit may be more intuitively edited, which can increase user convenience.

Although a digital camcorder 100 is described as the digital multimedia playback apparatus in describing aspects of the present invention, it is understood that such aspects are not limited thereto. Aspects of the present invention can be applied to any digital multimedia playback apparatus to which a touch screen is applicable and which provides an editing function, for example, a video apparatus such as a television (TV), a set-top box, a DVD player, a moving picture player, a compact disk (CD) player, a moving picture experts group-1 audio layer 3 (MP3) player, a mobile phone, a personal digital assistant (PDA) and an audio system, or a combination system comprising any combination thereof.

As described above, according to aspects of the present invention, user commands can be more intuitively and easily executed in a product to which a touch screen is applicable to thereby enhance user convenience.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A digital multimedia playback apparatus, comprising:
a display unit comprising a touch screen to display a list of items and a function icon; and
a controller to change a state of an item of the list to a state corresponding to the function icon, if a first user command is input through the touch screen to use the item and the function icon to apply the function to the item.

2. The digital multimedia playback apparatus of claim 1, wherein the digital multimedia playback apparatus is a photographing apparatus.

3. The digital multimedia playback apparatus of claim 1, wherein the first user command input starts with touching one of the item and the function icon and ends with touching the other one of the item and the function icon.

4. The digital multimedia playback apparatus of claim 1, wherein the function icon is selectable between a trash icon, a protection icon, and a playlist icon.

5. The digital multimedia playback apparatus of claim 4, wherein,
if the function icon is the trash icon, the controller deletes the touched item from a storage unit in which the touched item is stored;
if the function icon is the protection icon and if a command to delete the list is input, the controller deletes other items of the list, excluding the touched item; and
if the function icon is the playlist icon, the controller stores the touched item in a storage unit for a playlist.

6. The digital multimedia playback apparatus of claim 1, wherein,
if the list is an icon list and if a user command input starts by touching one of an item of the icon list and the function icon and ends by touching the other one of the item and the function icon, the controller exchanges on the display unit the position of the touched item with the position of the function icon, and controls the touched item so that the touched item operates as a function icon.

7. The digital multimedia playback apparatus of claim 1, wherein,
if a second user command is input by touching the function icon, the controller controls the display unit to display the items having the state that corresponds to the function icon.

8. The digital multimedia playback apparatus of claim 1, wherein the controller determines a touch start point of the first user command and a touch end point of the first user command and compares the touch start point to the touch end point.

9. The digital multimedia playback apparatus of claim 8, wherein,
if the touch start point and the touch end point are determined to be in different fields, the controller controls the display unit to display a confirmation message to request confirmation of changing the state of the item.

10. The digital multimedia playback apparatus of claim 9, wherein the controller changes the state of the item and displays a changed list according to the changed state of the item on the display unit if the change of the state of the item is confirmed.

11. A control method of a digital multimedia playback apparatus comprising a touch screen, the method comprising:
displaying a list of items and a function icon on the touch screen; and
changing a state of an item of the list to a state corresponding to the function icon if a first user command is input on the touch screen using the item and the function icon to apply the function to the item.

12. The control method of claim 11, wherein the digital multimedia playback apparatus having the touch screen is a photographing apparatus.

13. The control method of claim 11, wherein the first user command input starts with touching one of the item and the function icon and ends with touching the other one of the item and the function icon.

14. The control method of claim 11, wherein the function icon is selectable between a trash icon, a protection icon, and a playlist icon.

15. The control method of claim 14, wherein,
if the function icon is the trash icon, the changing comprises deleting the touched item from a storage unit in which the touched item is stored;
if the function icon is the protection icon and if a command to delete the list is input, the changing comprises deleting other items of the list, excluding the touched item; and
if the function icon is the playlist icon, the changing comprises storing the touched item in a storage unit for a playlist.

16. The control method of claim 11, wherein,
if the list is an icon list and if a user command input starts by touching one of an item of the icon list and the function icon and ends by touching the other one of the item and the function icon, the changing comprises exchanging the position of the touched item with the position of the function icon, and controlling the touched item so that the touched item operates as a function icon.

17. The control method of claim 11, wherein, if a second user command is input by touching the function icon, the changing comprises controlling the display unit to display the items having the state that corresponds to the function icon.

18. A control method of a video camcorder comprising a touch screen, the method comprising:
displaying a list of items and function icons;
detecting a touch on the touch screen;
determining whether a touch start position and a touch end position are in a same field;
changing a state of an item of the list to a state corresponding to one of the function icons if the determined fields are different; and
changing a state of one of the function icons if the fields are the same.

19. The control method of claim 18, wherein, if the touch start position is in a first area indicating a first function icon, and the touch end position is in a second area indicating a second function icon, the state of the first function icon is changed so that the first function icon is displayed in the second area, and the state of the second function icon is changed so that the second function icon is displayed in the first area.

20. A control method of a digital multimedia playback apparatus comprising a touch screen, the method comprising:
displaying function icons and list items on the touch screen;
detecting a touch on the touch screen;
determining a touch start position and a touch end position; and
changing a state of an item of the list items according to a function of one of the function icons when the touch start position is determined to be in an area of the one of the function icons and the touch end position is determined to be in an area of the item of the list items.

21. A digital multimedia playback apparatus, comprising:
a display unit comprising a touch screen to display list items and function icons; and
a controller to change a state of an item of the list items according to a function of one of the function icons when a touch start position is determined to be in an area of the one of the function icons and a touch end position is determined to be in an area of the item of the list items.
